(19) United States
(12) Patent Application Publication
(10) Pub. No.: US 2002/0067354 A1
(43) Pub. Date: Jun. 6, 2002

(54) Method and system for reconstructing 3D objects from free-hand line drawing

(76) Inventors: Beom-Soo Oh, Seoul (KR); Chang-Hun Kim, Seoul (KR)

Correspondence Address: Chung K. Ko, 1263 Lakeside Drive #2190, Sunnyvale, CA, 94085, US

(21) Appl. No.: 09/968,168

(22) Filed: Sep. 28, 2001

Related U.S. Application Data
(60) Provisional application No. 60/238,071, filed on Oct. 2, 2000.

(51) Int. Cl. G06T 17/00

(52) U.S. Cl. 345/420

(57) ABSTRACT

An efficient method is disclosed for reconstructing a 3D object from a free-hand line drawing. The search domain is reduced by classifying potential faces into implausible faces that cannot be actual faces, basis faces that are actual faces without search, and minimal faces that are undetermined. The actual faces of an object can be identified rapidly by searching the minimal faces only. In addition, the 3D regularities and quadric regularities are introduced to reconstruct various 3D objects more accurately.

### RELATED APPLICATION

This application claims the benefit of co-pending U.S. Provisional Application Ser. No. 60/238071, filed Oct. 2, 2000, entitled “Method and System for Reconstructing 3D Objects from Single Free-Hand Line Drawing.”

### BACKGROUND OF THE INVENTION

1. Technical Field

This invention in general relates to 3D visualization. More specifically, this invention relates to reconsturcing 3D objects from a free-hand line drawing.

2. Description of the Related Art

During the conceptual design stage of 3-dimensional (3D) objects such as mechanical parts, many designers draw the 3D objects of their ideas in free-hand line drawings on papers using pencil. The method of representing 3D information by using a line drawing is a natural way to describe geometrical information. This approach provides designers with the means to convey their ideas to a CAD system, which constructs an accurate 3D model. Once a 3D model is obtained, it can be manipulated or modified, and further details may be added to obtain a more accurate 3D model. Thus, it would be useful if a method can be developed that allows automatic reconstruction of a 3D objects from a free-hand line drawing.

Conventional methods for constructing a 3D object from a line drawing have the following limitations making it difficult to develop a practical reconstruction system. First, because 2D line drawing corresponds to potentially multiple 3D objects containing tremendous number of potential faces, the conventional methods require a combinatorial search of a large search space to identify the actual faces. Second, the reconstruction results tend to produce somewhat distorted 3D objects due to inherent inaccuracies in line drawing. Third, the error in reconstruction of a curved object is significantly increased because most of 2D image regularities are derived from planar configuration of 2D entities.

Therefore, there is a need for a novel method for quickly identifying the 2D actual faces of a 3D object and thereby reconstructing 3D objects efficiently from a single free-hand line drawing.

### SUMMARY OF THE INVENTION

It is an object of the present invention to provide a mechanism for identifying the 2D actual faces of a 3D object from a free-hand line drawing.

Another object of the present invention is to provide a mechanism for reconstructing a 3D object from a free-hand line drawing.

The foregoing objects and other objects are accomplished by providing a new method of minimizing the search space for finding the actual faces by classifying potential faces into implausible faces, basis faces, and minimal faces. By introducing topological constraints when considering the relation between line drawing and an object, the method finds implausible faces that cannot be actual faces, basis faces that can be determined to be actual faces without a search process, and minimal faces that are not determined to be actual faces without a search process. Because the reduced number of minimal faces can be searched, the method of the present invention enables fast identification of the 2D actual faces of an object. Further, the present invention reconstructs various 3D objects containing flat and quadric faces by introducing the constraints of 3D regularities and quadric face regularities.

### BRIEF DESCRIPTION OF THE DRAWINGS

FIG. 1 is an overview of the 3D reconstruction method of the present invention.

FIG. 2 is an illustration of potential faces.

FIG. 3 is an illustration of implausible faces.

FIG. 4 is a flowchart of the software implementing the present invention.

FIG. 5 is a graph showing the evaluation of 3D regularities in the case of polyhedral object.

FIG. 6 is a graph showing the evaluation of 3D regularities and quadric face regularities in the case of quadric object.

### DETAILED DESCRIPTION OF THE INVENTION

Overview of Reconstruction Process

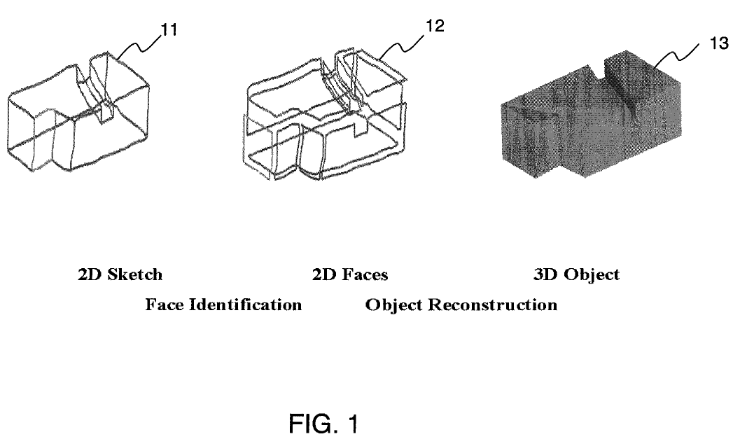

FIG. 1 shows an overview of the 3D reconstruction process of the present invention. The input is a 2D sketch 11 containing a free-hand line drawing. A 2D sketch represents a general object in a wire frame. The projection reveals all edges and vertices uniquely. In addition, all drawn lines represent real edges, silhouette curves or intersections of faces of the 3D object.

The present invention supports general objects (manifold and non-manifold) containing flat or quadric faces. Reconstruction of a 3D object from a 2D line drawing consists of two stages: face identification and object reconstruction. In the face identification stage, the method first analyzes the line drawing of an object to be modeled to obtain an edge-vertex graph, then it restore topological information of an object using topological/geometrical constraint of the edge-vertex graph, and identifies actual 2D faces 12 of the object to be modeled. In the object reconstruction stage, the method reconstructs geometrical information of an object by using various constraints of regularities and produces the corresponding 3D object such as 13.

Identification of Faces

Because there are numerous potential faces that potentially correspond to faces of the depicted object in a line drawing, it is necessary to reduce the search space of face identification. The present invention introduces several topological constraints to reduce the search space. In a preferred embodiment, potential faces (PF) are classified into the implausible faces (IF), basis faces (BF) and minimal faces (MF) as in Table 1.

TABLE 1
Classification of potential faces

| Classes | Description |
|---|---|
| Implausible faces (IF) | Those potential faces that cannot be actual faces |
| | due to topological constraint |
| Basis faces (BF) | Those potential faces that are identified as actual |
| | faces without combinational search |
| Minimal faces (MF) | Candidates for actual faces that are undetermined |
| | as to whether actual faces or not until search is |
| | done |

If the actual faces of an object are set to be AF, Eq. 1 through Eq. 3 may be derived, meaning that actual faces can be identified by searching minimal faces only.

IF∪MF∪BF=PF (1)

IF∩MF=MF∩BF=BF∩IF=Ø (2)

BF⊂AF,AF⊂(BF∪PF) (3)

Rank R(v) and R(e) are defined as the number of faces whose boundary contains that entity, and the upper bound of the ranks are denoted by R⁺(v) and R⁺(e) [3]. In addition, RF(v) and RF(e) are defined as the sets of faces whose boundary contains that entity. Classification of potential faces may proceed as follows:

[Face classification step]

Step 1. Generate all potential faces using n edges, i.e., PF. Initially, IF=MF=BF=ø.

PF=makeface{e₁,Λ,eₙ} (4)

Step 2. Find the implausible faces, IF, containing internal edge(s).

{f|f∈PF,[f=(f₁∪f₂)−(f₁∩f₂),if ∀e∈(f₁∩f₂), e is the internal edge of f]} (5)

Since Eq. 5 is not always true, some routines are added to recover over-reduced faces (Step 5).

Step 3. Find the basis faces, BF.

{f|f∈(PF−IF)=F,[Connected edges e₁,e₂,n[RF(e₁)∩RF(e₂)]=1,f∈RF(e₁)∩RF(e₂)]} (6)

Step 4. Find the implausible faces by using maximum rank.

{f|f∈(PF−BF−IF),[∃e,RBF(e)=R⁺(e),f∈(RF(e)−RBF(e))]} (7)

Step 5. Recover over-reduced minimal faces.

{f|f∈IF,F=(PF−IF),f∈makeface{e|(R+(e)−n(RF(e))≧1}} (8)

Step 6. Repeat step 3 through step 5 until there is no change of the face class. All faces in (PF-IF-BF) are undetermined minimal faces.

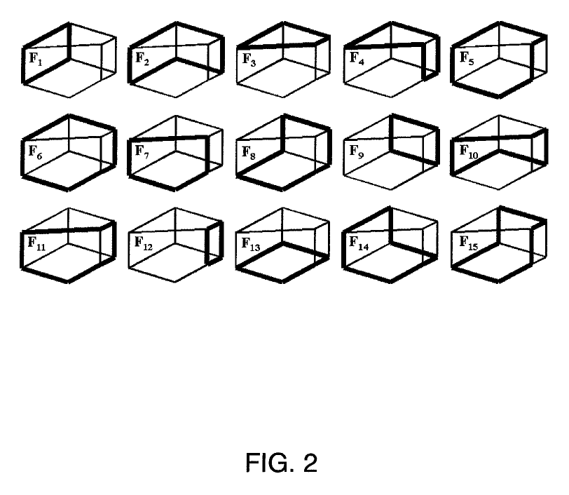

FIG. 2 shows an example of generating 15 potential faces from 2D sketch of itself according to the steps above.

In step 2, seven implausible faces, f₂, f₄, f₅, f₆, f₈, f₁₁, and f₁₄ are found. Applying Eq. 5, six basis faces, f₁, f₃, f₇, f₉, f₁₂, f₁₃ are found. However, according to the face adjacency relation, faces f₇, f₁₃ cannot coexist. Therefore, some constraints must be added into step 3.

{f|f₁,f₂∈BF,∀e∈(f₁∩f₂)are smooth.} (9)

By applying Eq. 9, two faces f₇ and f₁₃ remain as potential faces.

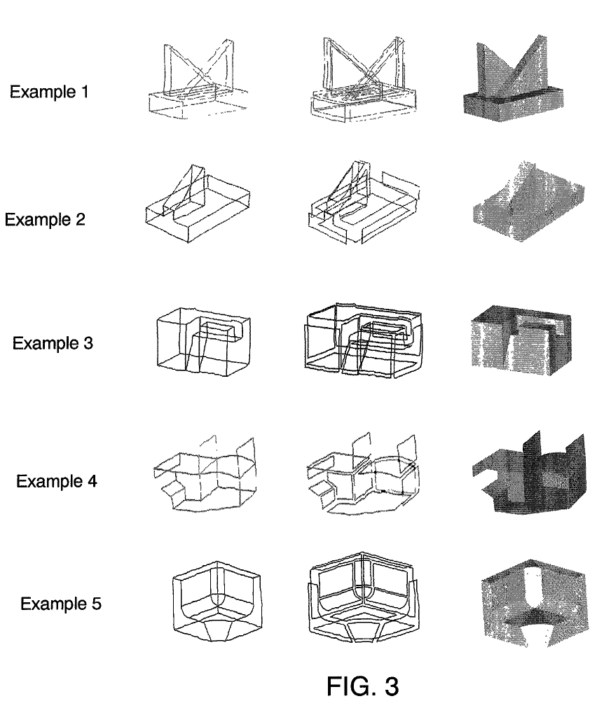

FIG. 3 shows implausible faces f₁₀ and f₁₅ that are found in step 4. Steps 5 and 6 do not make any changes in this example. Finally, four basis faces f₁, f₃, f₉ and f₁₂, and two minimal faces f₇ and f₁₃ are extracted. By searching the minimal faces only, the actual faces of an object can be identified rapidly.

Identifying faces of an object in sketch can be formulated as a selection problem, i.e., selecting k faces among the m potential faces such that the k faces represent a valid object by combinatorial searches 2^{m}.

The actual faces can be identified by using minimizing Eq. 10.

|R⁺(e)−R(e)|+|R⁺(v)−R(v)| (10)

By minimizing the number of minimal faces in the combinatorial search, the actual faces can be identified rapidly.

Reconstructing 3D Object

To reconstruct the geometrical information of the 3D object, a preferred embodiment of the present invention uses several geometric regularities. A 3D configuration can be represented in a compliance function by summing the contributions of the regularity terms. The final compliance function to be optimized takes the form of:

$${W}^{T} \sum [ {α}_{regularity} ] \qquad ( 11 )$$

But, the reconstruction results tend to produce a somewhat distorted 3D object due to the inherent inaccuracies in the sketch and 2D image regularities.

Some geometric regularity constraints of 3D regularities and quadratic face regularities are introduced with 2D geometric regularities to reconstruct 3D objects more accurately.

[Face parallelism]

A parallel pair of planes in the sketch plane reflects parallelism in space. The term used to evaluate is

$${α}_{{face}_{parallelism}} = {\sum }_{i = 1}^{n} {[ {cos}^{- 1} ( {n}_{1} \cdot {n}_{2} ) ]}^{2} \qquad ( 12 )$$

where, n₁ and n₂ denote all possible pairs of normal of parallel faces.

[Face orthogonality]

An orthogonal pair of faces in the sketch plane reflects orthogonality in space. The term used to evaluate is

$${α}_{{face}_{orthogonality}} = {\sum }_{i = 1}^{n} {[ {sin}^{- 1} ( {n}_{1} \cdot {n}_{2} ) ]}^{2} \qquad ( 13 )$$

where, n₁ and n₂ denote all possible pairs of normal of orthogonal faces.

It is simple to find parallel or orthogonal faces by using angular distribution graph that identifies prevailing axis system. First, each edge's prevailing axis is found. Then, all faces contain at most two prevailing axes. If two faces containing two axes have the same axes, and then they are parallel faces, else they are orthogonal faces.

In addition, simple radius regularities affecting quadric faces are introduced. [Radius equality]

$${α}_{{radius}_{equality}} = {\sum }_{i = 1}^{n} {( {d}_{1} \cdot {d}_{2} )}^{2} \qquad ( 14 )$$

where, d₁ and d₂ are distance from center of curve to the end-vertices.

In addition, a high weight is assigned to the regularity of face planarity to reconstruct the most plausible solution.

Software Implementation

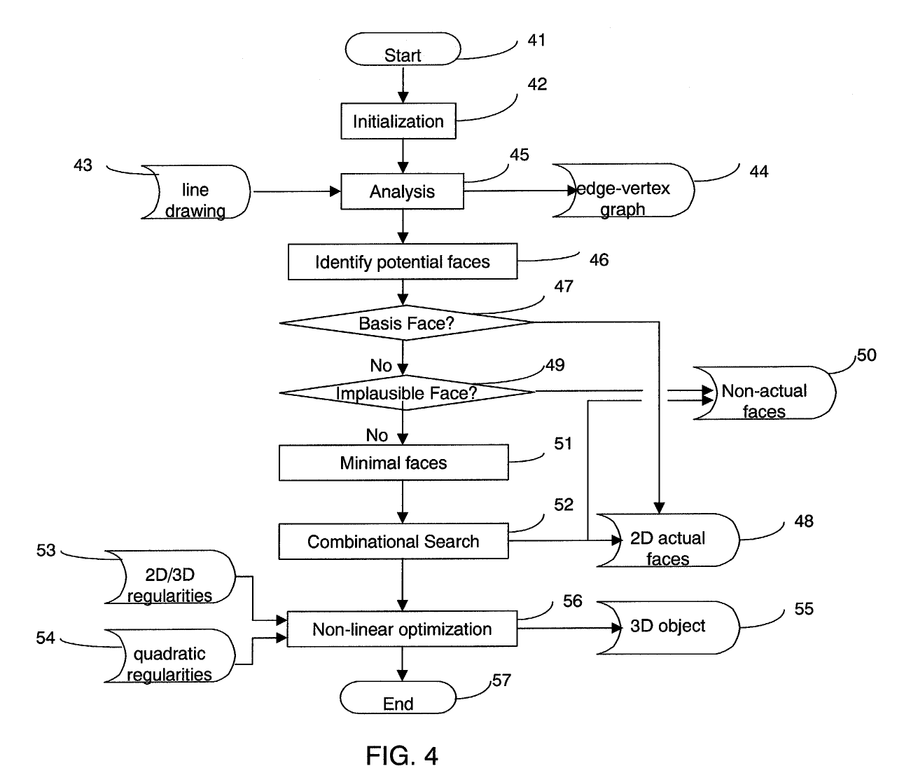

FIG. 4 shows the flowchart of the software that implements the 3-D reconstruction process. At the start 41, arrays and internal variables are initialized (step 42). The program takes a line drawing 43 and analyzes it to generate an edge-vertex graph 44 for the line drawing (step 45). The program first identifies all potential faces (step 46), and decides whether each of the potential faces is a basis faces that can be determined to be one of the actual faces 47 without any search (step 48), and whether each of the potential faces is an implausible faces that cannot be one of the actual faces due to topological constraints (step 49). The rest are minimum faces that are undetermined as to whether they are actual faces 48 or non-actual faces 50 until a search process is done (step 51). Combinational search is done to identify the actual faces (step 52). Nonlinear optimization is done using the constraints of 2D/3D regularities 53 and quadratic regularities 54 to reconstruct the 3D object 55 (step 56).

Experimental Results

To evaluate the efficiency of the method of the present invention, it is applied to various 3D objects shown in FIG. 3 and compared with a conventional method. The experiment was done on a PC with a Pentium III processor (450 MHz).

Table 2 shows that the method of the present invention efficiently narrows the search space of face identification down to a manageable size. The total time is dramatically reduced in most cases compared to the conventional method.

TABLE 2
Evaluation of face identification

| Kinds of | Method | Classification of faces | | | | | Time |
|---|---|---|---|---|---|---|---|
| 3D Object | Used | PF | IF | BF | MF | Sol | (msec) |
| Example 1 | A | 33 | 17 | 16 | 0 | 1 | 30 |
| | B | | 14 | — | 19 | | 142 |
| Example 2 | A | 37 | 25 | 8 | 4 | 2 | 60 |
| | B | | 18 | — | 19 | | 60 |
| Example 3 | A | 279 | 265 | 14 | 0 | 1 | 138 |
| | B | | 159 | — | 120 | | 1200 |
| Example 4 | A | 205 | 193 | 12 | 0 | 1 | 551 |
| | B | | 164 | — | 41 | | 1091 |
| Example 5 | A | 896 | 882 | 14 | 0 | 1 | 4420 |
| | B | | 679 | — | 202 | | 7283 |

A: method of the present invention, B: conventional method

To evaluate the effect of 3D regularities, the 3D errors and 2D errors are checked. A 3D error is defined as the distance between the depth of reconstructed object's vertices and the real depth of synthetic object's vertices, and a 2D error is defined as the sum of regularities.

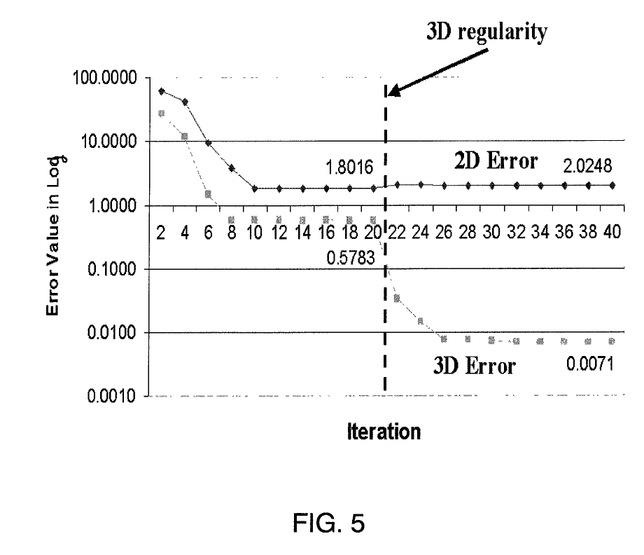

FIG. 5 shows the error performance when 3D regularities are introduced. The error curve shows that although 2D error is not improved, the constraints of 3D regularities improve the shape of reconstructed polyhedral object significantly.

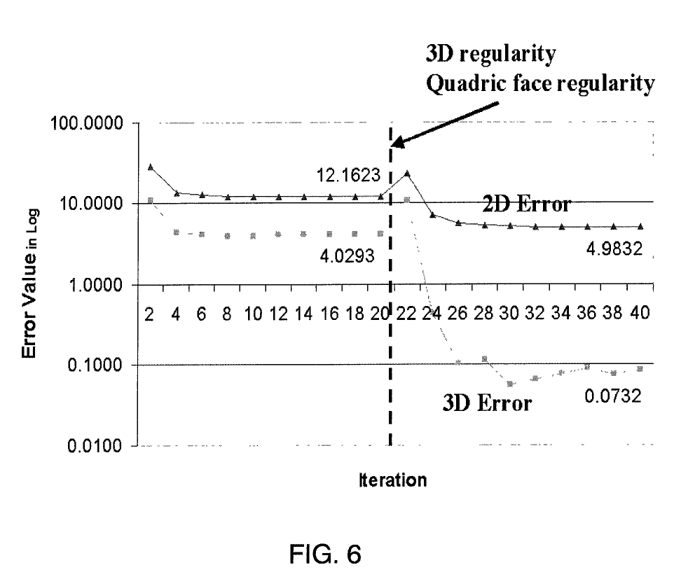

FIG. 6 shows the error performance when both 3D regularities and quadratic face regularities are used to improve the model. After 20 iterations, they can perturb the error curve as shown by a sudden spike. As more iterations are done, however, they significantly improve the shape of the object. Thus, they reduce 2D error as well as 3D error significantly in the case of a quadric object.

The present invention provides a handy interface that allows a designer to draw a conceptual design of an industrial product in a hand drawing and have it automatically converted to a 3D object in a form that can be further refined using a CAD system.

While the invention has been described with reference to preferred embodiments, it is not intended to be limited to those embodiments. It will be appreciated by those of ordinary skilled in the art that many modifications can be made to the structure and form of the described embodiments without departing from the spirit and scope of this invention.

What is claimed is:

1. A method of constructing a 3D object from a 2D line drawing, comprising the steps of:
deriving an edge-vertex graph from the 2D line drawing;
identifying actual faces from potential faces by searching for the actual faces after eliminating implausible faces that cannot belong to the actual faces using topological constraints, and
reconstructing a 3D object by utilizing geometric regularities based on the actual faces identified.

2. The method of claim 1, wherein the step of identifying actual faces further comprises the steps of:
finding basis faces that are identified as belonging to the actual faces without a search; and
finding minimal faces that are undetermined as to whether they belong to the actual faces or not before a search.

3. The method of claim 1, wherein the line drawing is a free-hand drawing.

4. The method of claim 1, wherein utilizing geometric regularities includes finding parallel faces.

5. The method of claim 1, wherein utilizing geometric regularities includes finding orthogonal faces.

6. The method of claim 1, wherein utilizing geometric regularities includes using radius regularity affecting quadratic faces.

7. A program product for constructing a 3D object from a 2D line drawing, wherein the program when executed in a computer performs the steps of:
obtaining an edge-vertex graph from the 2D line drawing;
identifying actual faces from potential faces by searching for the actual faces after eliminating implausible faces that cannot belong to the actual faces using topological constraints, and
reconstructing a 3D object by utilizing geometric regularities based on the actual faces identified.

8. The program product of claim 7, wherein the step of identifying actual faces further comprising the steps of:
finding basis faces that are identified as belonging to the actual faces without performing a search; and
finding minimal faces that are undetermined as to whether they belong to the actual faces or not before a search.

9. The program product of claim 7, wherein the line drawing is a free-hand drawing.

10. The program product of claim 7, wherein utilizing geometric regularities includes finding parallel faces.

11. The program product of claim 7, wherein utilizing geometric regularities includes finding orthogonal faces.

12. The program product of claim 7, wherein utilizing geometric regularities include using radius regularity affecting quadratic faces.
